(19) United States
(12) Patent Application Publication
(10) Pub. No.: US 2010/0299761 A1
(43) Pub. Date: Nov. 25, 2010

(54) SYSTEM AND METHOD FOR SENDING ELECTRONIC DATA TO INMATES

(75) Inventor: Ryan Jacob Shapiro, Bay Harbor Islands, FL (US)

Correspondence Address: FELDMAN GALE, P.A., 1700 Market Street, Suite 3130, Philadelphia, PA, 19103, US

(73) Assignee: JPay, Inc., Miami, FL (US)

(21) Appl. No.: 12/814,201

(22) Filed: Jun. 11, 2010

Related U.S. Application Data
(63) Continuation-in-part of application No. 11/041,431, filed on Jan. 21, 2005, now abandoned.
(60) Provisional application No. 60/538,933, filed on Jan. 22, 2004.

(51) Int. Cl. G06F 17/30

(52) U.S. Cl. 726/28

(57) ABSTRACT

The invention includes delivering and monitoring electronic letters to correction facility inmates while giving supervisory authorities the ability to screen the incoming mail. This may be achieved by providing a database having an entry for each inmate and having a plurality of fields, and by scanning an original letter as an electronic letter and storing each electronic letter sent to a specific inmate in a relational database management system (RDMS) table. Another aspect of the invention involves providing a computer-operated kiosk that may be used by individuals (e.g., inmates) in a restrained environment/restricted-access location (e.g., a prison) to browse through a catalog of available digital media or content, such as music, that may be purchase with credits earned based on work performed by the inmate or bought through some other means, for example by family members of the inmate.

### CROSS REFERENCE TO RELATED APPLICATION

This application for letters patent is a continuation-in-part of U.S. patent application Ser. No. 11/041,431, titled “PROCESS FOR SENDING ELECTRONIC CORRESPONDENCE TO INMATES,” and filed in the United States Patent and Trademark Office on Jan. 21, 2005, which in turn claims priority from provisional patent application 60/538,933 filed on Jan. 22, 2004.

### TECHNICAL FIELD OF THE INVENTION

The present invention relates to the field of electronic communications. Specifically, the present invention relates to the delivery and access of electronic data by individuals in a restrained environment, such as correctional facility.

### BACKGROUND OF THE INVENTION

Correction system authorities have found that receiving and distributing inmates' paper mail is a significant challenge. First, correction authorities frequently move inmates between correction facilities such as from a jail (where one is held prior to conviction) to a prison (where one is held after conviction). These movements, often on short notice, play havoc with conventional inmate mail. Conventional letters and other forms of correspondence, written on paper to be delivered to a physical address, are often lost or left “chasing” the inmate for years. This problem frustrates inmates, their families, attorneys and correction authorities. Second, correction authorities read inmate mail, a difficult, time consuming and expensive task especially when the mail is handwritten. Opening and reading inmate mail costs the American corrections system over $100 million per year. Third, correction authorities have no present way of storing and indexing inmate paper mail for later retrieval and analysis. Fourth, correction authorities inspect inmate mail for drugs or other forbidden substances, a difficult, time consuming and expensive task because some inmates may have clever cohorts outside of prison. Furthermore, drugs that remain undetected impose a large but unquantifiable cost on the incarceration system due to their deleterious impact on medical costs and violence. Fifth, as of December 2002, the United States federal, state and local authorities, most of whom are in budget deficit, incarcerated over two million people at a cost of more than $40 billion per year.

These challenges are not limited to the delivery of letters. For example, correctional authorities spend more time inspecting packages with gifts to be delivered to inmates than they spend on inspecting letters.

Therefore, there is a need in the art for a system and method for reducing inmate mail costs, eliminating the problems associated with an inmate's conventional physical address, improving delivery speed, eliminating drug and forbidden substance smuggling, and allowing better recordkeeping of incoming packages. The present invention addresses these needs.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention includes one or more databases, residing in one or more servers, that may be used as repositories of electronic data to be delivered to individuals in a constrained environment and/or restricted-access location, such as inmates. One aspect of the invention involves delivering and monitoring electronic letters to correction facility inmates while giving supervisory authorities the ability to screen the incoming mail. This may be achieved by providing a database having an entry for each inmate and having a plurality of fields, wherein the fields include inmate name, correction system identification code, inmate identification code, correction system facility code, wherein the facility code maps to a specific corrections facility; and by scanning an original letter to produce an electronic letter and storing each electronic letter sent to a specific inmate in a relational database management system (RDMS) table, wherein the RDMS table includes fields for inmate name, inmate identification number and lists of corrections facilities.

Another aspect of the invention involves providing a computer-operated kiosk that may be used by individuals (e.g., inmates) in a restrained environment/restricted-access location (e.g., a prison) to browse through a catalog of available digital media, such as music, that they may purchase with credits earned based on work performed or bought through some other means, for example with money deposited by family members of the inmate. The kiosk may include means for limiting access to the operating system or other modules in the kiosk computer so that inmates are blocked from accessing other machines with sensitive information that may be connected to the kiosk computer. After the user has browsed the catalog of digital content or media, selected the desired content (e.g., songs) and paid for the same, the purchased content may be downloaded to a digital content player device. The digital content player device may also be used to display correspondence to inmates.

The following description and the annexed drawings set forth in detail certain illustrative aspects of the invention. These aspects are indicative, however, of but a few of the various ways in which the principles of the invention may be employed and the present invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates an exemplary computing environment that may be used to implement a server in accordance with an embodiment of the present invention;

FIG. 2 illustrates a system in for routing electronic correspondence accordance with one embodiment of the present invention;

FIG. 3 illustrates a communications environment which may be used to deliver digital content in accordance with one embodiment of the present invention;

FIG. 4 illustrates a client and server architecture that may be used to implement a digital content store system in accordance with one embodiment of the present invention;

FIG. 5 illustrates a functional block diagram of a digital music player;

FIG. 6 illustrates a system for delivery of digital content in accordance with one embodiment of the present invention;

FIG. 7 illustrates the processing of a purchase order for a content player using a kiosk application in accordance with one embodiment of the present invention;

FIG. 8 illustrates a process for ordering and browsing content through a kiosk application in accordance with one embodiment of the present invention;

FIG. 9 illustrates content download processes in accordance with one embodiment of the present invention;

FIGS. 10-16 illustrate screenshots displayed by a kiosk terminal to allow a user to browse and purchase content and a content player in accordance with one embodiment of the present invention; and

FIG. 17 illustrates a system for delivery of digital content in accordance with another embodiment of the present invention.

### DETAILED DESCRIPTION OF ILLUSTRATIVE EMBODIMENTS OF THE INVENTION

The present invention may be implemented in one or more servers, one or more client devices, including computer terminals or portable client devices, or a combination thereof. The data to be accessed by end users in a restrained environment may be stored in one or more databases.

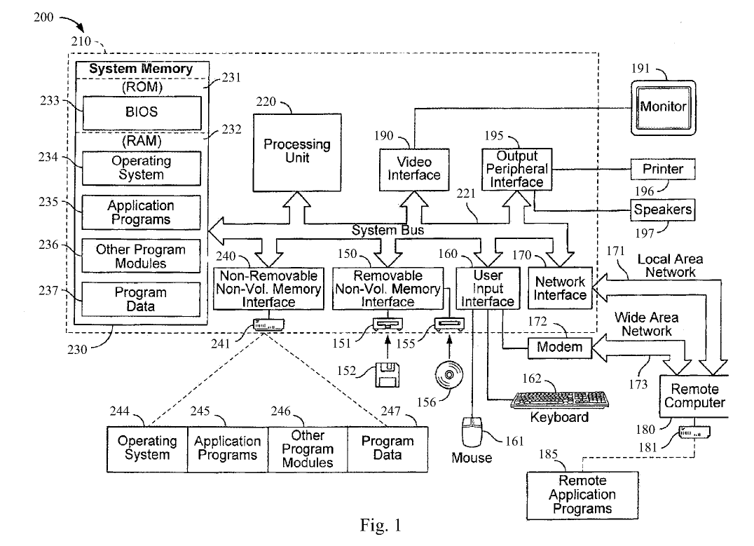

An exemplary computing device for implementing a server is illustrated in FIG. 1. For example, the computing environment illustrated in FIG. 1 may be used to implement a database server, an email server, a DNS server, a POP/IMAP server, a digital fulfillment server, a media server, a local server, a global server, etc.

FIG. 1 illustrates an example of a suitable computing system environment 200 on which features of the invention may be implemented. The computing system environment 200 is only one example of a suitable computing environment and is not intended to suggest any limitation as to the scope of use or functionality of the invention. Neither should the computing environment 200 be interpreted as having any requirement relating to any one or combination of components illustrated in the exemplary operating environment 200.

The invention is operational with numerous other computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by one or more computing devices. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system that may be used for implementing the invention includes a computing device 210 which may be used for implementing a server. Components of computing device 210 may include, but are not limited to, a processing unit 220, a system memory 230, and a system bus 221 that couples various system components including the system memory to the processing unit 220. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computing device 210 typically includes a variety of computer readable media. Computer readable media may be defined as any available media that can be accessed by computing device 210 and includes both volatile and nonvolatile media, removable and non-removable media. By way of example, and not limitation, computer readable media may include computer storage media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computing device 210. Combinations of the any of the above should also be included within the scope of computer readable media.

The system memory 230 may include computer storage media in the form of volatile and/or nonvolatile memory such as read only memory (ROM) 231 and random access memory (RAM) 232. A basic input/output system 233 (BIOS), containing the basic routines that help to transfer information between elements within computing device 210, such as during start-up, is typically stored in ROM 231. RAM 232 typically contains data and/or program modules that are immediately accessible to and/or presently being operated on by processing unit 220. By way of example, and not limitation, FIG. 1 illustrates operating system 234, application programs 235, other program modules 236, and program data 237.

The computing device 210 may also include other removable/non-removable, volatile/nonvolatile computer storage media. By way of example only, FIG. 1 illustrates a hard disk drive 240 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface such as interface 240, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computing device 210. In FIG. 1, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 220 through a user input interface 160 that is coupled to the system bus, but may be connected by other interface and bus structures, such as a parallel port, game port or a universal serial bus (USB). A monitor 191 or other type of display device may also be connected to the system bus 221 via an interface, such as a video interface 190. In addition to the monitor, computers may also include other peripheral output devices such as speakers 197 and printer 196, which may be connected through an output peripheral interface 195.

The computing device 210 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computing device 210, although only a memory storage device 181 has been illustrated in FIG. 1. In one embodiment of the present invention this computer 180 may be used to implement a kiosk for delivering digital media to an inmate or as a terminal for displaying correspondence to an inmate. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computing device 210 is connected to the LAN 171 through a network interface or adapter 170. When used in a WAN networking environment, the computer 210 typically includes a modem 172 or other means for establishing communications over the WAN 173, such as the Internet. The modem 172, which may be internal or external, may be connected to the system bus 221 via the user input interface 160, or other appropriate mechanism. In a networked environment, program modules depicted relative to the computing device 210, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

The present invention includes one or more databases, residing in one or more servers, that may be used as repositories of electronic data to be delivered to individuals in a restrained environment and/or restricted-access location, such as inmates. In general, a typical database is an organized collection of information structured such that a computer program, for example, can quickly search and select data. Traditionally, data stored within a database is organized via one or more tables, wherein respective tables comprise sets of records and a record comprises a set of fields. Records are commonly indexed as rows within a table and the record fields are commonly indexed as columns such that a row/column pair can reference particular datum within a table.

The database systems in accordance with embodiments of the present invention are not limited to relational database systems and organizing information in tables, although the invention will be described with respect to the usage of tables. For example, a database system in accordance with the present invention may generally store data in one or more data containers, each container potentially including one or more records, and the data within each record potentially being organized into one or more fields. In the context of relational database systems, these containers may be referred to as tables, the records may be referred to as rows, and the fields may be referred to as columns. In the context of object oriented databases, the data containers may be referred to as object classes, the records may be referred to as objects, and the fields may be referred to as attributes. A person of ordinary skill in the art would recognize that other database architectures may use other terminology.

For the purpose of explanation of the invention, the examples and the terminology used herein shall be that typically associated with relational databases. Thus, the terms “table”, “row” and “column” shall be used herein to refer respectively to the data container, record, and field. The present invention is not limited to any particular type of data container or database architecture.

A database server, in accordance with the present invention, retrieves and manipulates data in response to receiving a database statement conforming to a database language, such as for example, Structured Query Language (SQL). The database statement may specify a query operation, a data manipulation operation, or a combination thereof. A database statement that specifies a query operation is referred to herein as a query. The present invention is not limited to database statements that specify a particular type of operation. Database security mechanisms to restrict or expand access to a database have been described in U.S. Pat. No. 7,346,617 to Wong, incorporated herein by reference, and U.S. Pat. No. 7,661,141 to Dutta et al., incorporated herein by reference. One function of a database server in accordance with the present invention is to control access to database data.

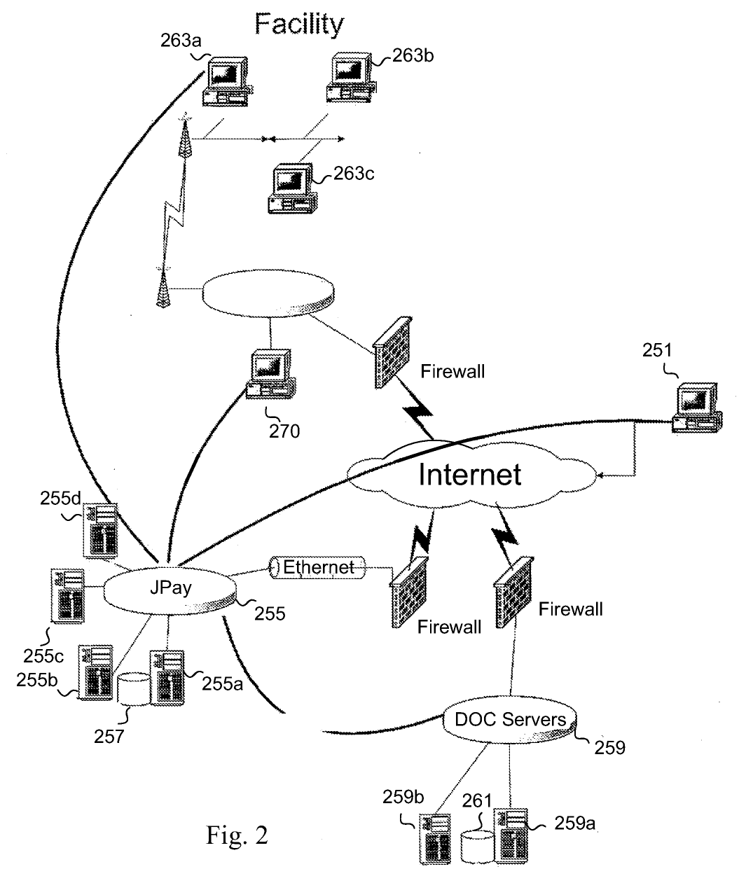

FIG. 2 illustrates a system in accordance with one embodiment of the present invention for routing electronic correspondence, such as letters and mail, to correction facility inmates that eliminates the delays, costs and risks associated with the current correction facility paper or hard copy mail system. The inventive system and method routes letters and other correspondence by using, for example, a table in database 257 that indicates the inmate's name, correction system code, inmate identification code and facility location code. The mail is either printed in the correction facility on a printing device connected to a computer or viewed in that facility on an electronic display device such as a personal computer or a visual display terminal (263a, 263b, 263c), while giving supervisory authorities the ability to screen the incoming mail through a terminal 270.

Aspects of one embodiment of the present invention may include providing a database 257 having an entry for each inmate and having a plurality of fields, with the fields in turn including inmate names, correction system identification codes, inmate identification codes, correction system facility codes which indicates a specific correction facility; and storing each electronic letter sent to a specific inmate in a relational database management system (RDMS) table, the RDMS table including fields for inmate name, inmate identification code and lists of corrections facilities. The database 257 may also include a table that includes entries for all inmates in a correction system or a correction facility.

The database may be maintained by periodically downloading a file from the correction authority central computer server farm 259 (including, for example, servers 259a-b) for such changes as new inmates, inmate releases and inmate movement between facilities. In one embodiment of the present invention, the downloading step is performed daily and the database may be arranged to provide for correction authority letter search and retrieval by the inmate name, inmate identification code, date, facility or keyword. In one embodiment, the database table includes at least three fields selected from the following group: (1) an inmate's last name, (2) an inmate's first name (3) an inmate's identification code, (4) an inmate's correction system code, (5) an inmate's correction system facility code and (6) other information if needed.

The present invention includes a letter creation and transmission website that may be maintained by server farm 255 (including, for example, servers 255a-d and database 257) that can be used by a person desiring to write letters to an inmate and that optionally assesses a fee for each letter sent. The website may be configured so that the writer can store and review his or her letter drafts. The writer may receive e-mail notification at computer 251 when his or her letter has been printed in the inmate's facility and delivered to the inmate and/or viewed by the inmate through a computer terminal (e.g., 263a, b, c) at the inmate facility, or viewed through a digital content player. In an alternative embodiment, the writer may scan the desired correspondence or document through use of a scanner and upload the scanned document to the website for forwarding to the inmate. In yet another alternative embodiment, a message delivered to an inmate may include photos or videograms attached thereto, which may be displayed at a kiosk or digital content player at the inmate's facility. Conversely, an inmate may use a kiosk or digital content player to create outbound messages directed to family members, for example, and distributed through use of the communications architecture of the present invention.

Aspects of another embodiment of the present invention includes including in the database 257 one or more tables having a plurality of fields, with the plurality of fields including at least two fields selected from a group consisting of inmate name, inmate identification code or other identifier, and inmate facility name or facility code; providing an electronic interface accessed through computer 251 for a writer, wherein the electronic interface allows the writer to specify the inmate or inmates that are the intended recipient(s) of the writer's communication, space for text of the mail or correspondence, and a system enabled by server farm 255 for purchasing “postage” to transmit the mail or correspondence; and maintaining a database table, the database table including (1) a list of letters sent by a specific writer, (2) a list of letters that the inmate has received, and (3) a list of privileged writers. The database table may also include a table entry indicating whether that letter has been previously read by the correction authorities and by whom; a table entry indicating which letters have as yet not been reviewed; and/or a table entry indicating who has been using the process to send letters to which inmates and at which facilities.

The database table may also include a table entry allowing authorities to search scanned letters for certain keywords. Preferably, the database table further comprises a table entry indicating privileged writers, such as attorneys, whose communications may be marked as privileged when printed or displayed and whose letters will be marked as not for correction authority inspection. Preferably, the database table further comprises a table entry indicating keywords that are of interest to the correction authorities. Preferably, the database table further comprises a table entry indicating to whom each writer is sending letters.

The inventive system and method provides an electronic letter routing software system that can be implemented on a network, including the Internet. Routing of mail is described in U.S. Pat. No. 7,647,380 to Gillum et al. which is incorporated herein by reference. In a preferred embodiment of the inventive system and method, several database tables are created in database 257, including but not limited to:
An inmate table that identifies the inmates and related information
A facility table that identifies the facilities and related information
A writer table that identifies the writers and related information
A credit card table that identifies the credit cards that the writer uses
A letter table that identifies the letters and related information
A privileged writer table that identifies the writer as a privilege communicator
A keyword table that lists the keywords of concern to the prison authorities

### Inmate Location

The inventive system and method creates, via regular downloads from the correction authorities' database (e.g., 261) associated with a correction authority's central computer (e.g., 259a, b), a table that includes inmate names, correction system identification codes, inmate identification codes, correction system facility codes and optionally other information.

The correction system identification code uniquely identifies a particular correction system such as a state, county or federal system.

The inmate identification code uniquely identifies a particular inmate within a particular correction system such as a state, county or federal system.

The correction system facility code uniquely identifies the correction facility within the correction system that holds that particular inmate. This facility code thereby determines which letters will be placed into that facility's mail file during the next mail delivery (or download).

The inventive system encodes the correction facility internally, preferably as a four character sequence where the first two characters identify the state and the second two characters identify the facility within that state. As a non-limiting example, New York's Dannemora prison is coded as “NYDA” while the Federal government's prison at Danbury, Conn. is coded as “FDDA”. Preferably, the facility code is case insensitive. Such an encoding scheme allows for 1,296 (36 squared (letters A-Z number 0-9) facilities within a corrections system (e.g., AA through 99).

### The Inmate Table

Preferably, an inmate table includes the following fields in a database:
Inmate's last name
Inmate's first name
Inmate's identification code
Inmate's correction system state, county or federal code
Inmate's correction system facility code
   Other information if needed, such as device ID for the digital content player

### Facility Setup

A facility is added to the inventive system via an input screen. Preferably input data requested includes, but is not limited to, facility code, facility name, mail delivery times and other information if needed. More preferably, the facility location is further included, or the inmate location (i.e., cell block) within a particular facility.

The inventive system then performs validity checks. Such validity checks may include, for example, determining if the facility is already in the table. If the data are valid the facility is added to the database table.

### The Facility Table

A facility table comprises at least one field selected from the group including:
A four (“4”) character alphanumeric facility identifier
The facility name
The facility address
Facility mail delivery times
Other information if needed

### Writer Registration

Before sending an initial letter, a writer first opens an account by filling out an input form that requires data, such as a username, a password and an optional e-mail address.

Preferably, a password system further lets the writer enter a hint question so that if he forgets his password he can be reminded. For example, the writer might enter a password of “lion” and have a question to remind him of that password that asks, “What is my favorite animal?”

The process or software then performs various validity checks (such as email verification or credit card verification with name and address). If a writer proves to be a valid writer, the writer is added to the writer table and assigned a unique identification number.

### The Writer Table

The writer table comprises at least one field selected from the group including:
Writer's username
Writer's password
Writer password hint
Writers e-mail address (optional)
Writer (system assigned) unique identifier
Amount of postage writer has remaining

### Purchasing “Postage”

In order to send a letter the writer buys “postage” by entering his or her credit card information. The amount of the postage is stored on the writer's table. The process creates a unique credit card/username identifier for each writer.

### The Credit Card Table

The Credit Card table includes:
Writer unique identifier
Card name (Visa, MasterCard, Amex, etc. . . . )
Card number
Expiration
Unique credit card/username identifier
Unique credit card validation number

### Billing Records

The billing table displays the amount and date of postage purchased on that credit card.

### The Billing Table Includes:

Unique credit card identifier
Transaction date
Transaction amount

### Sending Letters

To compose a letter the writer uses a letter-input screen. This screen resembles a standard letter with the writer's address on the upper right and recipient's address on the lower left.

The writer can insert the inmate's address into the letter in several different ways.

First the writer identifies the inmate's corrections system. If the inmate is incarcerated in New York, for example, the writer can specify that state by typing NY or by using a “pull down” menu.

The writer can then enter the inmate's identification code and the inmate's name and address will automatically fill in.

Alternatively, the writer can address the letter by entering the inmate's last name. If several inmates share that last name, the system will list all inmates with that last name, their first names, their inmate identification codes, and their facility locations. The writer selects the correct inmate and the address automatically fills in.

The writer then enters the letter's text and clicks the send button. The letter is added to the letter table and the writer is informed of the next mail delivery. The writer may then exit the process or write another letter.

### Storing the Letters

The inmate letters are stored on the server 255. The status of each letter is also stored. Such status indicates whether the letter has already been downloaded and read, whether the letter should be held for review and which keywords may have been detected.

### The Letter Table

A preferred embodiment includes, for example:
A unique inmate identifier
A unique writer identifier
A facility code
Time and Date Letter was created
Time and Date Letter was delivered
Correction review (yes/no)
Hold/Release flag
Keyword Triggers
Text of Letter

### Writer Interaction

The process has a screen that lets the writer review his activity. First, the writer can see a detailed list of the inmates to whom he has sent letters. Second, the writer can see a list of the letters that he has sent to a particular inmate. Third, the writer can read a letter that he previously sent.

### Corrections Authorities—Getting the Mail

The facility mail file may be stored on the server and may be retrieved by the facility mailroom. Alternatively, the file may be emailed to the facility.

Facility mailroom employees retrieve the mail file via a web page that allows them to create the mail file dynamically from the letter table. The mailroom employee enters name and password. Thereupon, to create the mail file, the process creates a list of letters for that facility in preferred order (e.g., alphabetized by inmate name) and a cover sheet listing the letters. The process then creates a download file that includes the cover sheet followed by the letters in the preferred order.

Once the download is completed the letter table is updated to indicate that the letters have been downloaded at the facility. The writers are then e-mailed that the letters have been printed.

### Correction Authorities Interaction

Correction authorities read inmate mail, except for privileged correspondence, for example between an attorney and his or her (inmate) client. First, correction authorities can see a chronological list of letters sent to the inmate and can print inmates' letters either individually or collectively. Second, correction authorities are alerted if inmate letters contain prohibited keywords. Third, correction authorities can read letters and indicate in the letter table that a particular letter has been reviewed and if held for review subsequently released to the inmate. Fourth, correction authorities can search across all inmate letters in the correction system for commonalities and keywords.

### Delivery of Digital Content

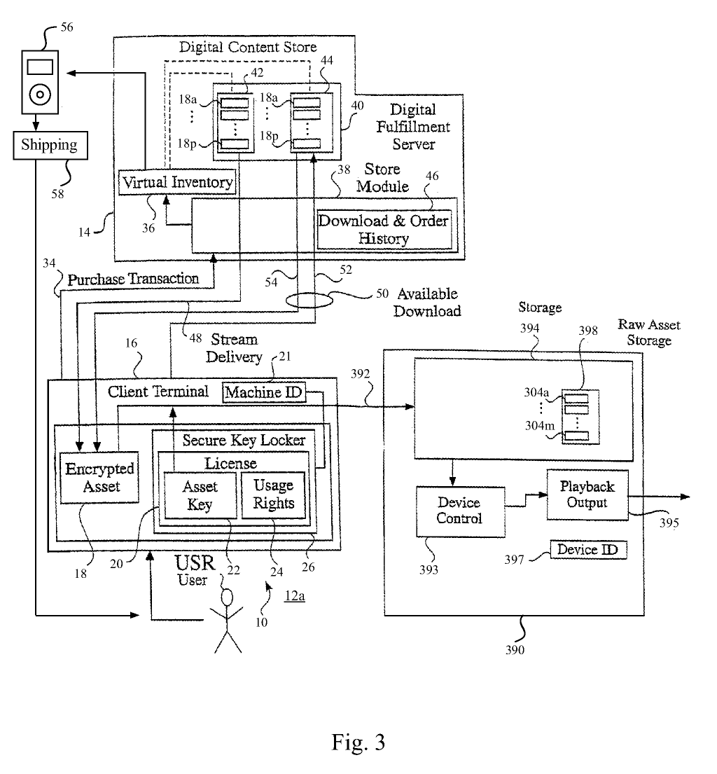

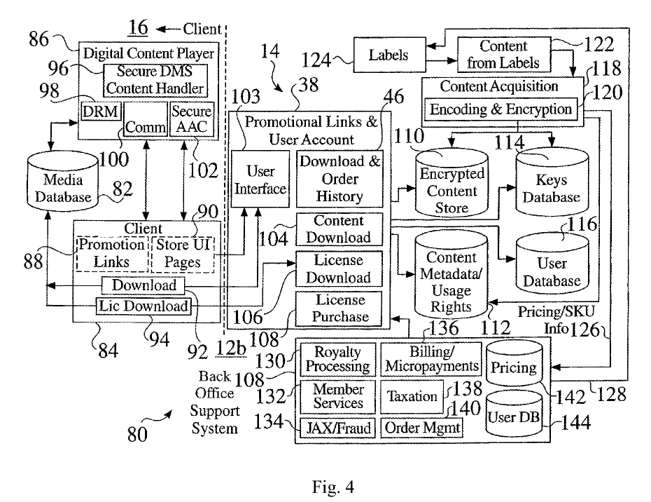

Another embodiment of the present invention includes the delivery of digital content, such as music, to inmates. FIG. 3 illustrates a communications environment, parts of which may be used in the implementation of the digital content delivery aspect of the present invention. FIG. 3 is a basic schematic diagram 10 of a digital content store system 12a implemented between a digital content store 14 and a client machine 16. A user USR at a client machine 16 may access the digital content store 14 through a store link and account module 38, such as through a user interface 103 (FIG. 4). The store module 38 is typically associated with a selectable inventory 36 of assets (e.g., songs), which are typically accessible 42, 44, upon purchase or other redemption, as encrypted assets 18, e.g., 18a-18p, such as through a digital fulfillment center 40. The content store 14 may also maintain a history of ordered and downloaded assets 46.

A user USR at a client machine 16 may purchase encrypted assets 18 (e.g., encrypted songs), through the entry of purchase information 34, whereby the encrypted assets 18 are delivered, such as through downloading 50, which may include a download prompt 52 and download delivery 54, wherein the download delivery 54 comprises both asset delivery and license delivery to the client 16. In another embodiment of the present invention the assets need not be encrypted.

In some system embodiments 12, the user USR may also use the system to purchase physical inventory of content 56, e.g., an MP3 player pre-loaded with songs, which are then shipped 58 to the intended user USR. Upon purchase 34, some system embodiments comprise both delivery of physical content 56, along with downloading of encrypted digital content 18, whereby the intended user USR can quickly access content 18, such as songs, movies, games, or other content 18.

As seen in FIG. 3, license information 20 for an encrypted asset 18 includes the asset rights for the encrypted content 18, and may include both an asset key 22 and usage rights 24, which are retained within a secure key locker 26. In one embodiment, the asset key 22 is bound to the client machine 16, such as through machine fingerprinting or in conjunction with the machine identification 21.

Usage of the encrypted asset 18 typically includes writing or uploading 392 the asset 18 and license information (e.g., key 22 and usage rights 24) to a digital content player 390. The digital content player includes a device control 393 module to direct the operations of the player 390, a unique device ID 397, and a module 395 for outputting content in a format that can be played or further modified such that a user can perceive. The player 390 may also include the capabilities of decrypting the assets and moving the raw assets 304 to a raw asset storage area 398 within the player's memory 394.

The player may also store encrypted assets in memory 394 and playback the encrypted assets 18 by retrieving the asset rights 20, whereby the asset key 22 operates upon the asset 18, such as through decryption, decoding and/or rendering. The enabled asset is then played as desired by the user USR, in compliance with the usage rights 24.

An authorized use of the encrypted asset 18 may include an authorized transfer 29 of the asset 18 to media or storage on a player 390, e.g., an MP3 player, or to another machine 16, as allowed by usage rights 24. In conjunction with an authorized transfer 392, a modified license 20 may be included with the encrypted asset 18, such as comprising an asset key 22 which is unbound from the primary client machine 16, and a portion of appropriate usage rights 24, e.g., such as for authorizing use of physical media 56.

FIG. 4 is a detailed schematic diagram of client and server side architecture within a digital content store system 12b. This environment or parts thereof may be used to implement certain features of the present invention. Client software 84 provides communication functionality to server 14, and to a digital content player 86, e.g., a music player. A media database 82 may reside in the client computer and may store assets, such as acquired encrypted assets 18, and may be used to store other assets, such as unencrypted assets and/or associated metadata.

The client software 84 typically comprises a download module 92, a license download module 94, and may also comprise other functionality, such as stored user interface pages 90 and/or promotional links 88, e.g., for a digital content store 14.

The digital content player 86 may include a secure digital content/music store (DMS) content handler 96, digital rights management (DRM) 98, dedicated communications module 100, and secure advanced audio coding (AAC) 102.

On the server side 14, promotional links and user account 38 typically comprise a user interface 103, download and order history 46, content download 104, license download 106, and license purchase 108. An encrypted content store 110 stores encrypted content 18, such as is available for purchase within the digital content store system 12. Other server storage comprises content metadata and usage rights 112, keys database 114, and a user database 116.

As seen in FIG. 4, raw content 122, such as from labels 124, is sent to content acquisition 118, wherein the incoming raw content 122, which may include raw assets and associated metadata, may be processed within an encoding and encryption module 120.

The back office support system 108 shown in FIG. 4 comprises pricing 142, a user database 144, royalty processing 130, member services 132, billing and micropayments 136, taxation 138, order management 140, and jax/fraud 134. Pricing/SKU information 126 is typically sent to the back office support system 108, such as from metadata 306 received at content acquisition 118. As well, royalty reporting or other output information 128 is typically sent from the back office support system 108 to the labels 124.

As seen in FIG. 4, content and associated license information is sent from the server 14 to the client machine 16, through the client software 84. Encrypted content 18 is transferred to the media database 82, where it is retrievable for usage through the digital content player 86. As needed, the digital content player 86 may interact through the client software 84, such as to communicate with the server 14, e.g., to update usage information, or to prompt the user USR to acquire or extend asset rights 20.

During playback of acquired assets, the digital content player playback engine extracts the asset key 22 from the secure key locker 26, and then decrypts, decodes, and renders the asset 18. The media pipeline is protected up until the handoff to the sound card.

If the digital content player 86 detects that the key 22 is missing, or is not valid for the machine 16 in question, the digital content player 86 may first play a sample of the song 18, e.g., such as a 30 second clip, and then the digital content player 86 presents the user USR with a purchase opportunity. If the user USR chooses to purchase 34, the user is taken to the digital music store 14 to complete the process 34. The entire key mechanism is preferably seamless to the user experience.

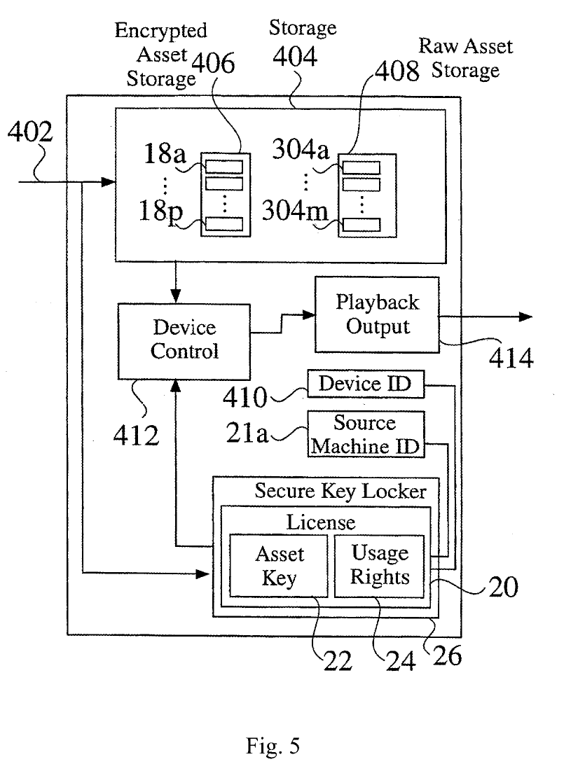

FIG. 5 is a functional block diagram of an alternative digital music player 400 including asset security for encrypted assets 18. Encrypted content 18a-18p is typically transferred from a client machine 16, in compliance with allowed usage rights 24. Some embodiments of the player 400 additionally provide storage and playback of raw, i.e., unencrypted assets 304a-304m. As seen in FIG. 4, the player 400 typically comprises similar internal digital rights management capabilities, such as a secure key locker 26, and an extended license 20, comprising asset keys 22 and usage rights 24 for the encrypted content 18. The player may typically store one or more device IDs 21, to track the source machine 16 from which content 18 is received. The device may also include a device ID 410, which is used for machine-bound content management. In some embodiments of the secure content player 400, the player 400 is considered to be a client machine 16, such as for licensing purposes. The player 400 may be considered to be an independent player, such as for licensed usage allowed for a user USR of one or more client machines 16.

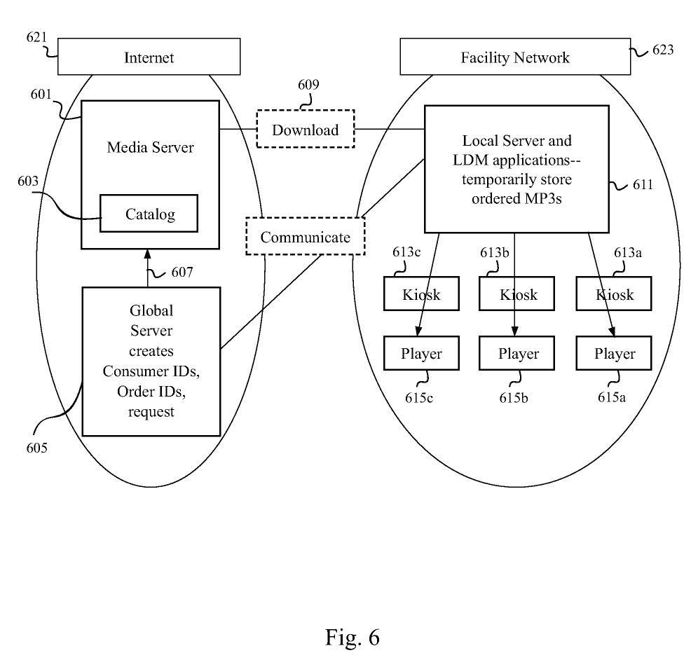

The system and method of the present invention allow inmates to buy digital media, including individual songs, albums and eBooks, from an Inmate Kiosk and download it to a personal portable player of digital content (the “Player”) securely while ensuring the protection of content owner rights. The system of the present invention in accordance with one embodiment (FIG. 6) may include the following components:
Global Server 605: Administers services to an online store running in server 601 and eCommerce over the Internet 621.
Inmate Kiosks 613a-c: Allow inmates to securely interact with local server 611 over a secure facility network 623. In one embodiment, the kiosk terminals 613a-c do not allow localized storage or access to regular Windows-level folders. Each kiosk terminal may run a kiosk application to prevent the inmates from treating the terminal as a regular PC with OS access. The kiosk application ensures that the kiosk is solely used as a window into the local server 611 and local download manager (installed in the server 611) and only connects to the web for specific pre-approved functions within the media store (run by server 605), such as listening to song previews from the content provider's server 601. To prevent OS access, software such as siteKiosk from Provisio may be used.
Local download manager (“LDM”): This application may run on the Local Server 611 and administers the synchronization of media delivery between the Global Server 605, Inmate Kiosk (e.g., 613a), and a Player (e.g., 615a). Content resides on the Local Server 611 and LDM, which is then delivered to Player 615a-c through the corresponding kiosks 613a-c.
Digital Content Player (or Player): The portable digital content player may be purchased by an inmate. An inmate synchs the Player and downloads files securely through a kiosk after purchase of content using a personal account created and maintained at the Global Server 605. The Player may be implemented as a custom-made device for the corrections industry that allows delivery only of approved content via specific USB codes which prevent unauthorized connections. All inmate interaction with the Global Server 605 and the Media Server 601 is conducted using a unique inmate ID to ensure security and prevent cross-pollination or abuse of account information or purchased media.

In one embodiment of the invention the digital content includes music and may be maintained in a catalog 601 by a content aggregator (e.g., third-party Neurotic Media) at a Media server 601. In an alternative embodiment the system administrator for server 605 may also administer the media server 601. In another embodiment of the invention, the player displays inmate correspondence.

In one embodiment, the content aggregator obtains the content from the different music labels to update the catalog 603 and uniformly funnels the content catalog over the Internet to the Global Server 605 as XML files. The Server 605 loads the catalog 603 from the MEDIA SEVER 601 and processes it to fit any general or specific restrictions. The catalog may include links to previews and album art which reside on the Aggregator's site at all times and are provided through a direct link from the kiosk.

The Global Server 605 may get daily updates to the catalog from the media server 601 using SOAP API. To purchase a song from the Aggregator, the Global Server 605 also may use SOAP API. After a purchase is made, the Global Server 605 sends download instructions to the local server 611 to download the songs. The inmate then connects to the kiosk which in turn copies the files from the local server 611 to the digital content player.

The Local Download Manager (LDM) may be implemented as a standalone executable used to manage the content downloads between the Local Server 611 and Players 615a-c (using the kiosks 613a-c as enabling pass-through units). In one embodiment, the LDM centralizes management of all tasks, for example content downloads, local storage, etc., in one location per inmate facility, and the Local Server 611 runs separately and is not physically accessible to inmates. The LDM may include predefined settings which provide general information about the Aggregator's site (URL, user name, password etc.). The LDM transfers information about processed orders into a file system in the local server 611 before a content download begins. The order for content contains inmate ID, song name, and access instructions. Each completed delivery of content to the Player is reported back to the Global Server 605 and the Local Server 611 and stored on a file system locally at Local Server 611. The kiosk deletes the content file copy from the local server 611 after it is transferred from the local server network drive directly to the Player (i.e., after successfully copying the files to the digital content player).

In one embodiment of the present invention, the LDM communicates with the global server 605 over Web Services and LDM acts as the client (e.g., LDM will pull information from global server 605). The LDM may be accessed through a management console with HTTP based user interface (“UI”) and may also have a local text based log file to describe main actions.

The LDM may obtain specific downloaded instructions from the Global Server 605. Local Server 611 downloads the content from the media server 601, stores the content on its local file system, and provides the kiosk access to the stored content to retrieve songs, for example, and deliver them onto the Player. Each inmate may have a directory on the local file system with subdirectories for downloads and galleries and can only access his or hew own account.

In one embodiment of the present invention, a kiosk terminal 613 has pre-defined settings to access the local server 611 file system root directory using a share drive mechanism. The local server 611 notifies the kiosk 613 when content is ready to be downloaded to the player 615, after which the inmate will able allowed to start downloading media directly to a registered Player. The Player may connect to the kiosk through a standard USB port.

After connecting the player to the kiosk, the kiosk identifies the player, for example, based on the inmate id or other identification parameters embedded in the player during the fulfillment process. Unrecognized players/devices are not immediately served. When the kiosk matches the inmate id to the Player and session id, the player is allowed to download content. At the start of the download, the kiosk accesses the inmate directory on the local server file system and copies all new files in this directory directly to the Player (one-way synch process). Download includes copy or, if configured, moves the content files from the inmate folder on the LDM directory to the player. In one embodiment, files will not be saved on the kiosk file system. Preferably, the player should not be disconnected from the kiosk while downloading content. The kiosk may display a message to the inmate such as “Downloading, do not disconnect.” The Kiosk application disables an auto logout feature during download and resumes when the download is complete.

After download of content is complete:
1. A summary message is displayed to the inmate (songs, price, etc).
2. A status change notification of a completed download is sent to the local server.
3. Kiosk application collects the player's statistics (number of songs and available space) and sends it back to the local server.

When the kiosk is in the process of authenticating an inmate, if the kiosk does not match the inmate id to the Player and session id, the kiosk will stop serving the player and perform the following actions:
1. Kiosk sends a notification back to the local server 611 to be propagated to the appropriate facility user. This prevents the inmate from continuing to use the unauthorized device by either moving all songs from the player to the inmate directory on the LDM or disabling the Player.
2. Kiosk displays a message to the user and marks his account as “Locked.”

In addition to facilitating the downloading of content into the player, the kiosk application is responsible for the Player maintenance and control in accordance with one embodiment of the invention. Each Player is registered to one inmate and includes a unique ID to be matched with a specific inmate ID. Each kiosk can only access the inmate's account on the Local Server 611.

Player access to the kiosks may be restricted by “burning” an individual inmate ID into the player device's memory. In one embodiment, the kiosk allows downloads for inmates that authenticate themselves at the kiosk and then connect a Player with a matching ID. If the Player is NOT verified the kiosk sends a “lock” command to the Player to prevent further use.

In a preferred embodiment of the invention, there are two specific methods of communication with the Player. In a first method of communication, a specific driver allows interaction between the kiosk and the player only if the driver is loaded to the kiosk terminal (this eliminates unauthorized PC connections). The “mass-storage” capabilities may be excluded from the driver to eliminate the risk of using the player as a flash drive. In one embodiment of the invention, the driver allows the player and player software to communicate with the kiosk application, so if the driver is not loaded the player cannot communicate with the kiosk.

In a second method of communication between the kiosk and the player, a .COM object or .NET assembly is loaded in real-time by the kiosk application or software library and is compiled to the kiosk application with the following functions:

Int GetInmateID (string PassKey)—return inmate id or −1 if wrong passkey or inmate id is not available. Passkey may be defined as a predefined string used for security purposes.
Int PutInmateID (string PassKey, string id)—store a new id on the device.
Bool ChangePassKey (string currenPassKey, string newPassKey)—change the passkey.
Int GetDevice serialID (string PassKey)—get a unique serial id (optional).

The following functions lock the player if the special driver is not available. The kiosk application locks the player after download and unlocks it again before the next download.
Bool LockDevice (string PassKey)—disable the device from receiving any files until unlock function is called (Bool UnLockDevice (string PassKey)—enable device for receiving any files.
Bool RemoveLock (String passkey)—remove the locking (i.e. allow receive files from any source).

The .NET object or wrapper serves as a translator between the kiosk application and the player software.

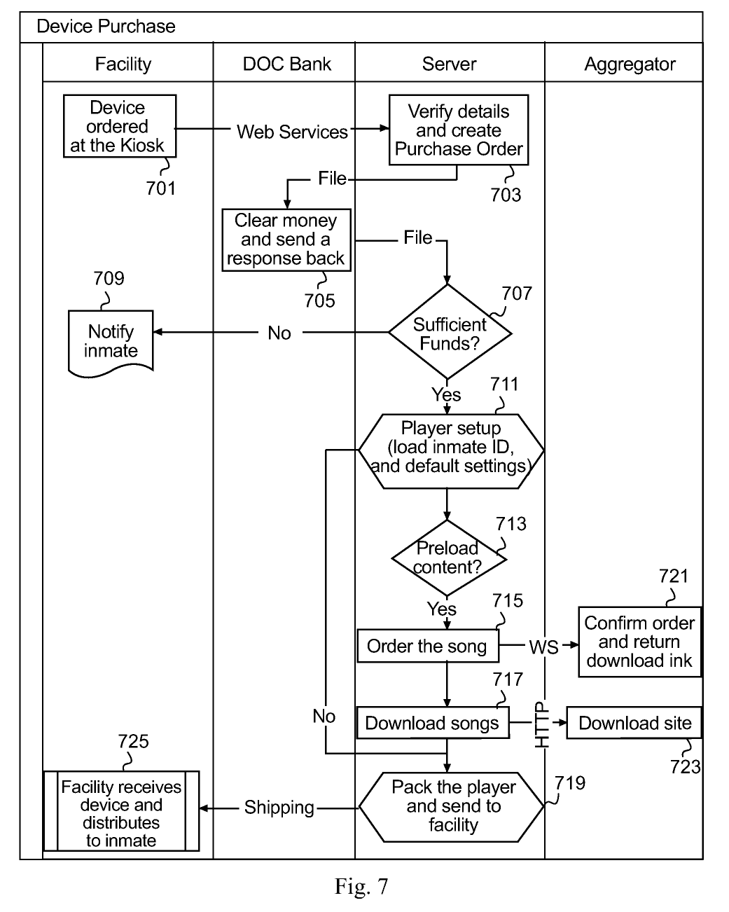

FIG. 7 illustrates a method for processing a purchase transaction for a player using the kiosk application. At step 701 the inmate places an order using the kiosk terminal. The order is communicated to the global server via web services. At step 703 the global server verifies details of the order and creates a purchase order. The global server verifies that the order amount can be cleared by the Department of Corrections (“DOC”) Bank. At step 705 the DOC Bank sends a response to the global server to notify whether there are sufficient funds in the account associated with the inmate making the request. An inmate account can be replenished through deposits made on behalf of the inmate by family or friends, or in the alternative, through work programs established by the corrections facility, for example. At step 707, if the global server determines that there are not sufficient funds, then the inmate is notified through the kiosk terminal, for example.

If the global server determines that there are sufficient funds, then global server creates a player setup file. This file includes the inmate ID and other default settings. The file is then uploaded into the ordered player. If the inmate does not select an option to preload the player with content, then the player is packed and shipped to the inmate's facility (step 719).

If the inmate selects an option to preload content into the player (step 713), then global server requests the pre-required content (e.g., songs), from the media server. This request may be made over web services. At step 721 the media server confirms the order for purchase of a song, for example, and in response to the request returns a link for downloading the content. After receiving the link, the global server downloads the songs (step 717) over an http connection from a download site (e.g., the media server). After the player is preloaded with content, the player is packed and shipped to the inmate's facility (step 719). At step 725 the player is distributed to inmates.

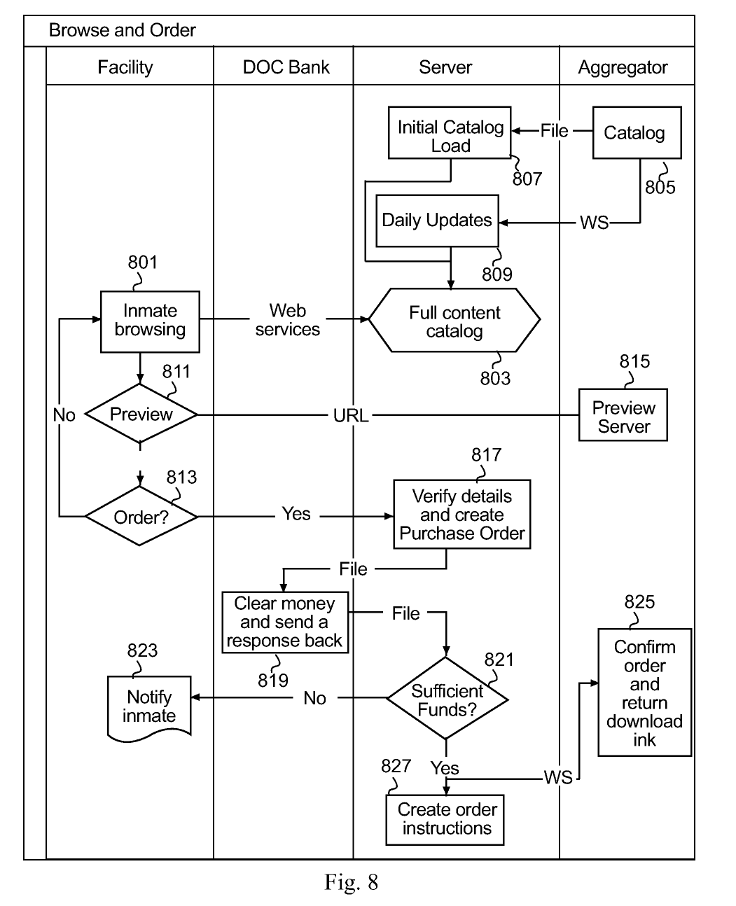

FIG. 8 illustrates a process for ordering and browsing content through the kiosk terminal. At step 801 the inmate initiates browsing through the kiosk terminal. The local server may communicate with the global server over web services to access the catalog (step 803). The catalog residing in the global server is first uploaded 807 from the media server 805 over an Internet connection. Daily catalog updates may be transmitted to the global server over web services 809.

In step 811 the kiosk presents an option to preview the catalog. The preview may be accessed directly by clicking on a URL link to the media server, for example (step 815). Either after previewing content or skipping the preview option, the inmate may use the kiosk terminal to order content (step 813). The kiosk sends a request for selected content to the global server and the global server verifies details of the order and creates a purchase order (step 817). The global server verifies that the order amount can be cleared by the DOC Bank. At step 819 the DOC Bank sends a response to the global server to notify whether there are sufficient funds in the account associated with the inmate making the request. At step 821, if the global server determines that there are not sufficient funds, then the inmate is notified through the kiosk terminal (step 823), for example.

If the global server determines that there are sufficient funds, then global server sends a request to the media server to confirm the order and the media server returns confirmation and a link for downloading the content (step 825). The global server also creates order instructions to the local download manager including inmate ID, location, download URL, and download time, for example.

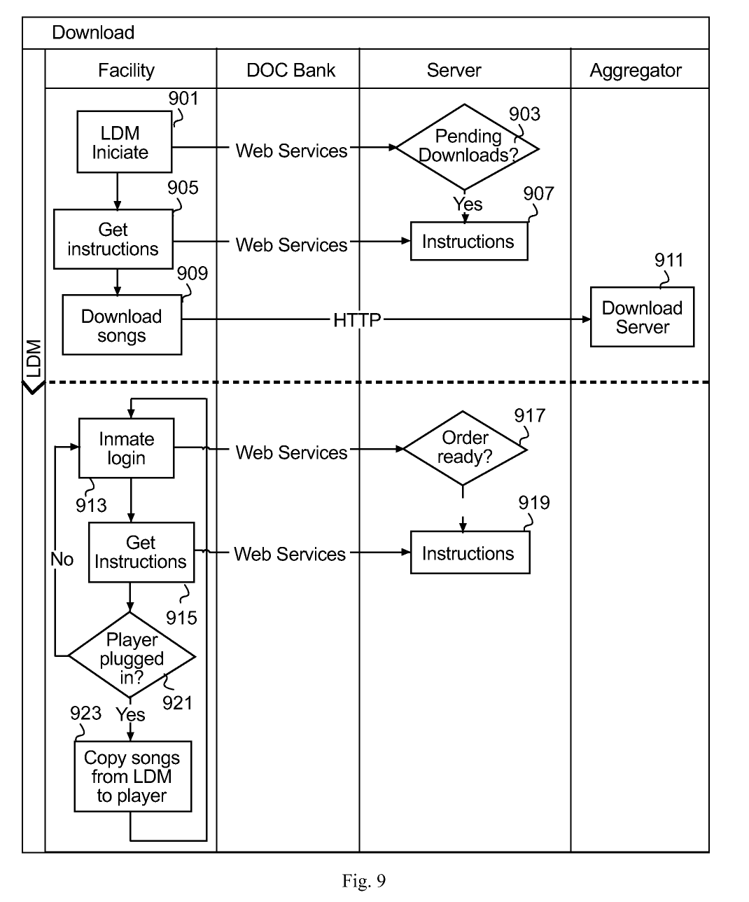

FIG. 9 illustrates content download processes in accordance with one embodiment of the present invention. At step 901 the LDM running in the local server initiates the content download process by first checking whether there are any pending downloads. The LDM initiates and sends a startup message to the global server over web services and in response to the request the global server verifies whether the local download manager has new pending downloads (step 903). If there are pending downloads, at step 907 the global server creates instructions for downloading content that include instructions to finish pending downloads. For example, if there are pending downloads, the global server creates instructions so that at the next communication cycle the local download manager will retrieve the instructions and download the content. Otherwise at step 907 creates download instructions that do not include pending downloads. At step 905 the LDM obtains download instructions from the global server, again communicating with the global server over web services. At step 909 the LDM initiates download of content, for example music, from the media server by establishing an http connection with the media server. At step 911 the content is downloaded from the media server.

At step 913 the kiosk terminal displays a login screen to an inmate. After log in, the kiosk checks whether an order for content is ready. The kiosk sends a request to the global server over web services and in response to the request the global server verifies whether the inmate order for content is ready (step 917). If the order is ready, at step 919 the global server creates instructions for authorizing delivery of content to the player. At step 915 the kiosk obtains the order instructions from the global server, again communicating with the global server over web services. For example, the global server may direct the kiosk to access the local download manager to copy content awaiting to be downloaded by inmates.

At step 921 the kiosk determines whether the content player is plugged in to the kiosk, and if it is not the inmate may be taken back to the login screen. If the player is connected, then content is copied from the LDM to the kiosk and then to the player at step 923. After the download is complete, the kiosk displays a login screen again.

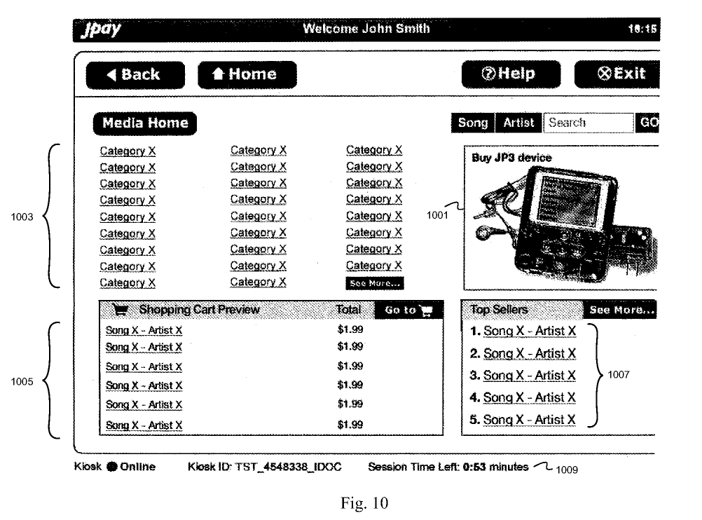

Other aspects of browsing and ordering content will be described below with reference to FIGS. 10-16. Generally, the local server provides the kiosk with specific offerings per inmate based on restrictions set by the facility. Inmates log into the kiosk and then browse through the catalog of specific offerings.

The searchable catalog may be organized based on artists, albums or genres. Content length, cost and position in the album may be displayed at the song level.

Song previews may be played and listened to at the kiosk (via LDM connection to the Internet and onto the media server site), and album covers may be displayed, as well as artist images when available. Previews may be available per song by routing the requests for previews in real time to the media server. The preview may be secured behind a Flash button to prevent a localized download of the preview clip. After accessing previews inmates may order a number of songs, based on their account balance, or purchase a full album. Once the order is complete a confirmation appears notifying the inmate about cost of order and order processing time. Inmates may check on their order status at any given time during the download process. The global server keeps a status record of every order for audit purposes. For example, each component in the system may send a status update of the content (e.g., pending, purchased, downloaded, copied, etc.) to the global server.

FIG. 10 illustrates an exemplary screenshot that may be displayed by the kiosk terminal. The kiosk may display an image of a content Player which inmates can order through the kiosk (1001). The kiosk may display categories of music (1003). These categories may include rock, rap, R&B, etc. The kiosk may also display the content items that an inmate has already selected for purchase (1005). The kiosk may also display the top selling songs 1007.

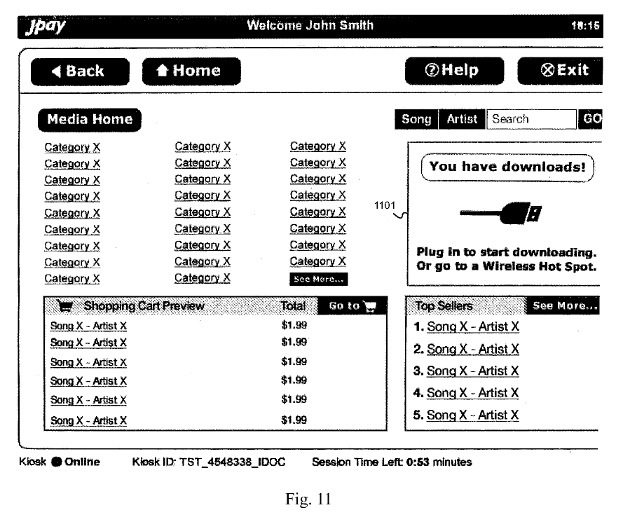

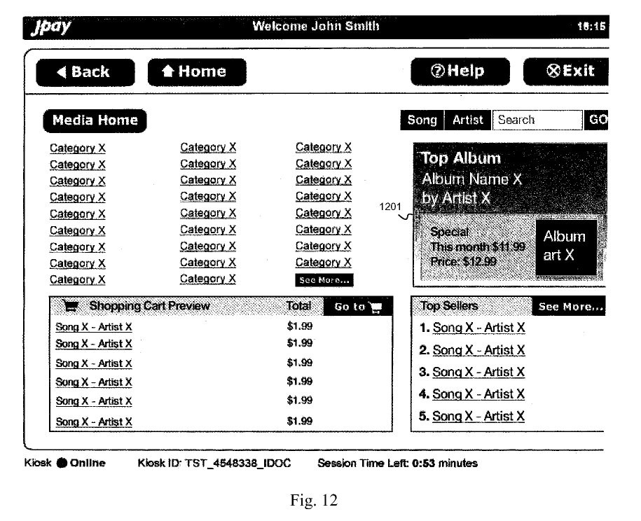

FIG. 11 illustrates a screenshot similar to that in FIG. 10 except that the kiosk displays a message that content is ready to be downloaded. The content may be downloaded by the inmate physically connecting the Player to the kiosk, or in an alternative embodiment, by wirelessly connecting the player to the kiosk my moving the player to a wireless hotspot. FIG. 12 illustrates advertisements that may be displayed by the kiosk. In the illustrated exemplary display, the inmate is presented with an offer to buy a top selling album (1201).

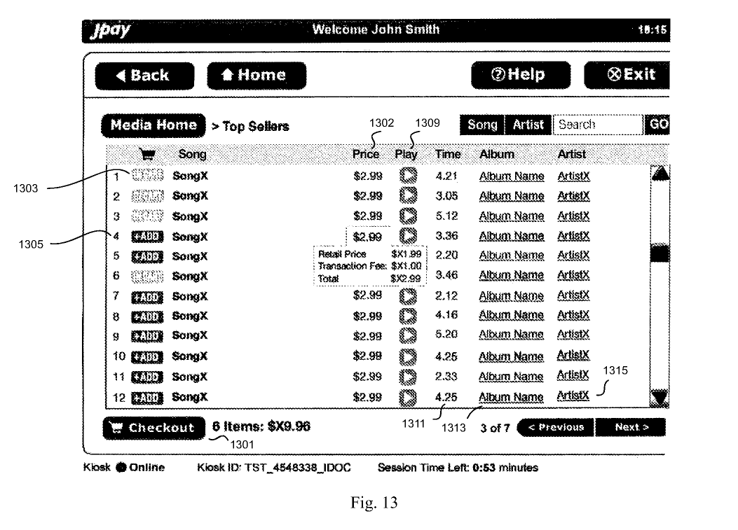

FIG. 13 illustrates a screenshot of the kiosk displaying top selling songs. The kiosk may display whether the songs have already been added to a shopping cart (1303) or not (1305). Other information related to each song may also be displayed, for example, the price 1302, the length of the song 1311, the album 1313, and the artist 1315. An option to play a clip of the song may also be displayed 1309 as well as an option to checkout 1361.

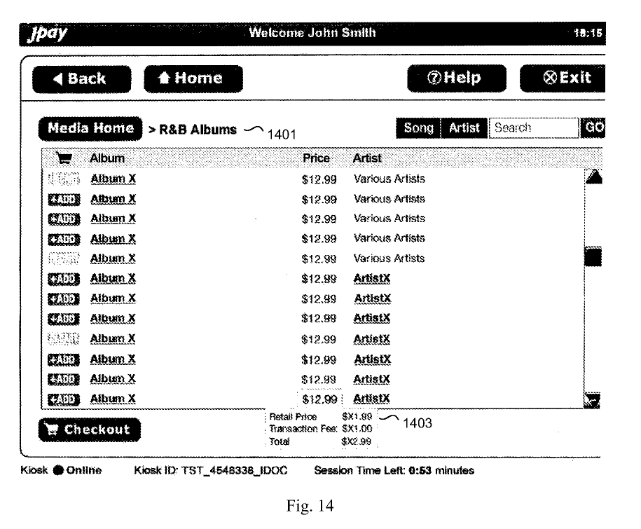

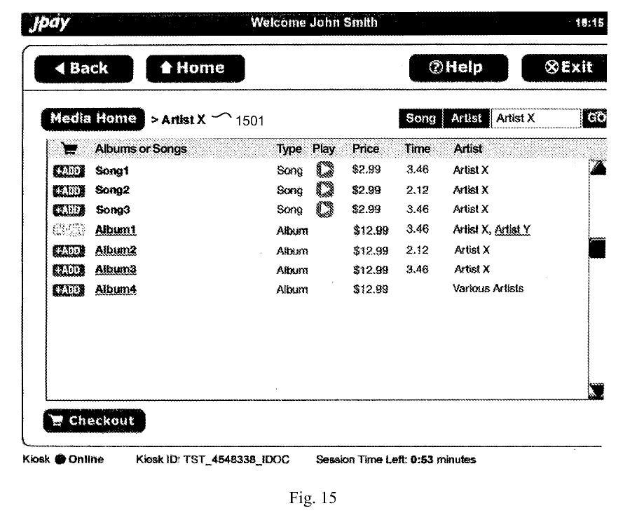

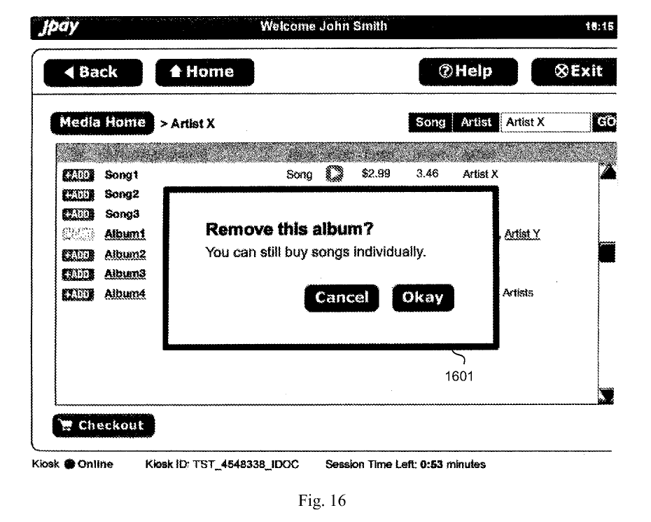

FIG. 14 illustrates a screenshot of songs displayed by the kiosk under the R&B category 1401. The kiosk also displays the price per song, transaction fee, and the total price 1403. FIG. 15 illustrates a screenshot of songs displayed by the kiosk under the Artist category 1501. FIG. 16 illustrates a screenshot of the kiosk displaying an option to remove content previously added to the shopping cart 1601.

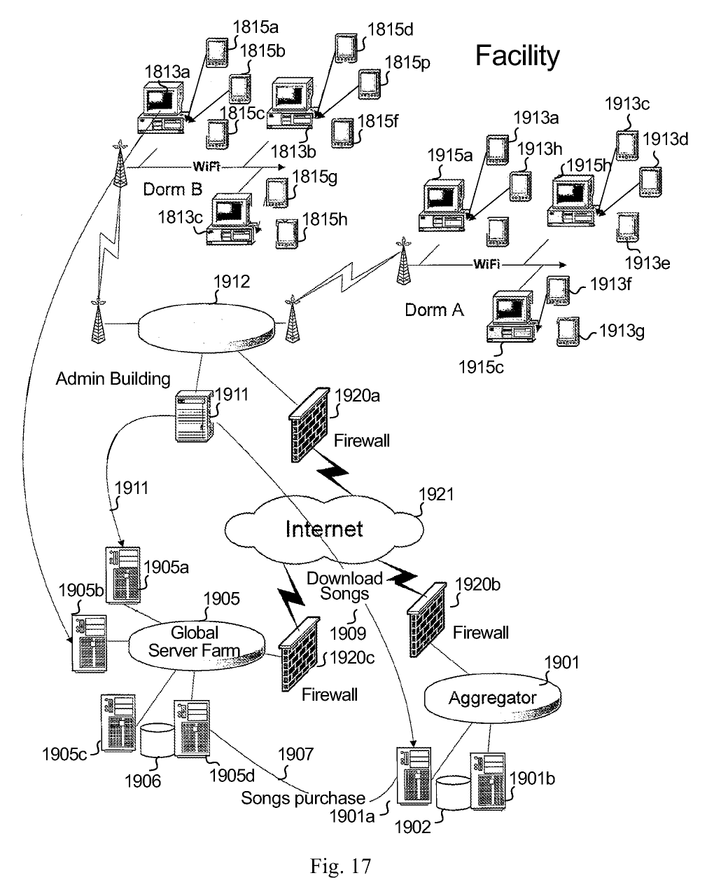

The system of the present invention in accordance with another embodiment (FIG. 17) may include the following components:
Global Server Farm 1905: The Global Server Farm 1905, including servers 1905a-d and a database 1906, administers services to an online store running in Aggregator 1901 and eCommerce over the Internet 1921. The Aggregator 1901 may include servers 1901a-b and a database 1902.
Inmate Kiosks 1813a-c and 1913a-c: Allow inmates to securely interact with local server 1912 and LDM 1911 over a secure facility network. In one embodiment, the kiosk terminals do not allow localized storage or access to regular Windows-level folders. Each kiosk terminal may run a kiosk application to prevent the inmates from treating the terminal as a regular PC with OS access. The kiosk application ensures that the kiosk is solely used as a window into the local server 1912 and local download manager 1911 and only connects to the web for specific pre-approved functions within the media store (run by global server farm 1905), such as listening to song previews from the content provider's Aggregator 1901. To prevent OS access, software such as siteKiosk from Provisio may be used.
Local download manager (“LDM”): This application may run on the Local Server 1912 or may run on a separate machine 1911. The LDM administers the synchronization of media delivery between the Global Server Farm 1905, Inmate Kiosk (e.g., 1913a), and a Player (e.g., 1915a). Content resides on the Local Server 1912 and the LDM 1911, which is then delivered to Players through the corresponding kiosks.
Digital Content Player (or Player): The portable digital content player may be purchased by an inmate. An inmate synchs the Player and downloads files securely through a kiosk after purchase of content using a personal account created and maintained at the Global Server Farm 1905. The Player may be implemented as a custom-made device for the corrections industry that allows delivery only of approved content via specific USB codes which prevent unauthorized connections. All inmate interaction with the Global Server Farm 1905 and the Aggregator 1901 is conducted using a unique inmate ID to ensure security and prevent cross-pollination or abuse of account information or purchased media.

In one embodiment of the invention the digital content includes music and may be maintained in a catalog by the content aggregator 1901 (e.g., third-party Neurotic Media). In an alternative embodiment the system administrator for Global Server Farm 1905 may also administer the Aggregator 1901. In another embodiment of the invention, the player displays inmate correspondence, including pictures and videograms.

In one embodiment, the aggregator 1901 obtains the content from the different music labels to update the catalog and uniformly funnels the content catalog over the Internet to the Global Server Farm 1905 as XML files. The Global Server Farm 1905 loads the catalog from the Aggregator 1901 and processes it to fit any general or specific restrictions. The catalog may include links to previews and album art which reside on the Aggregator's site at all times and are provided through a direct link from the kiosk.

The Global Server Farm 1905 may get daily updates to the catalog from the Aggregator 1901 using SOAP API. To purchase a song from the Aggregator 1901, the Global Server Farm 1905 also may use SOAP API. After a purchase is made, the Global Server Farm 1905 sends download instructions to the local server 1912 to download the songs. The inmate then connects to the kiosk which in turn copies the files from the local server 1912 to the digital content player.

The Local Download Manager (LDM) may be implemented as a standalone computer 1911 used to manage the content downloads between the Local Server 1912 and Players (using the kiosks as enabling pass-through units). In one embodiment, the LDM 1911 centralizes management of all tasks, for example content downloads, local storage, etc., in one location per inmate facility, and the Local Server 1912 runs separately and is not physically accessible to inmates. The LDM 1911 may include predefined settings which provide general information about the Aggregator's site 1901 (URL, user name, password etc.). The LDM 1911 transfers information about processed orders into a file system in the local server 1912 before a content download begins. The order for content contains inmate ID, song name, and access instructions. Each completed delivery of content to the Player is reported back to the Global Server Farm 1905 and the Local Server 1912 and stored on a file system locally at Local Server 1912. The kiosk deletes the content file copy from the local server 1912 after it is transferred from the local server network drive directly to the Player (i.e., after successfully copying the files to the digital content player).

In one embodiment of the present invention, the LDM 1911 communicates with the Global Server Farm 1905 over Web Services and LDM 1911 acts as the client (e.g., LDM 1911 will pull information from Global Server Farm 1905). The LDM 1911 may be accessed through a management console with HTTP based user interface (“UI”) and may also have a local text based log file to describe main actions.

The LDM 1911 may obtain specific downloaded instructions from the Global Server Farm 1905. Local Server 1912 downloads the content from the Aggregator 1901, stores the content on its local file system, and provides the kiosk access to the stored content to retrieve songs, for example, and deliver them onto the Player. Each inmate may have a directory on the local file system with subdirectories for downloads and galleries and can only access his or her own account.

In one embodiment of the present invention, a kiosk terminal (e.g., 1813a-c or 1915a-c) has pre-defined settings to access the local server 1912 file system root directory using a share drive mechanism. The local server 1912 notifies the kiosk when content is ready to be downloaded to the player, after which the inmate will be allowed to start downloading media directly to a registered Player. The Player may connect to the kiosk through a standard USB port.

After connecting the player to the kiosk, the kiosk identifies the player, for example, based on the inmate id or other identification parameters embedded in the player during the fulfillment process. Unrecognized players/devices are not immediately served. When the kiosk matches the inmate id to the Player and session id, the player is allowed to download content. At the start of the download, the kiosk accesses the inmate directory on the local server file system and copies all new files in this directory directly to the Player (one-way synch process). Download includes copy or, if configured, moves the content files from the inmate folder on the LDM directory to the a player. In one embodiment, files will not be saved on the kiosk file system. Preferably, the player should not be disconnected from the kiosk while downloading content. The kiosk may display a message to the inmate such as “Downloading, do not disconnect.” The Kiosk application disables an auto logout feature during download and resumes when the download is complete.

After download of content is complete:
1. A summary message is displayed to the inmate (songs, price, etc).
2. A status change notification of a completed download is sent to the local server.
3. Kiosk application collects the player's statistics (number of songs and available space) and sends it back to the local server.

When the kiosk is in the process of authenticating an inmate, if the kiosk does not match the inmate id to the Player and session id, the kiosk will stop serving the player and perform the following actions:
1. Kiosk sends a notification back to the local server 1912 to be propagated to the appropriate facility user. This prevents the inmate from continuing to use the unauthorized device by either moving all songs from the player to the inmate directory on the LDM or disabling the Player.
2. Kiosk displays a message to the user and marks his account as “Locked.”

In addition to facilitating the downloading of content into the player, the kiosk application is responsible for the Player maintenance and control in accordance with one embodiment of the invention. Each Player is registered to one inmate and includes a unique ID to be matched with a specific inmate ID. Each kiosk can only access the inmate's account on the Local Server 1912.

Player access to the kiosks may be restricted by “burning” an individual inmate ID into the player device's memory. In one embodiment, the kiosk allows downloads for inmates that authenticate themselves at the kiosk and then connect a Player with a matching ID. If the Player is not verified the kiosk sends a “lock” command to the Player to prevent further use.

In a preferred embodiment of the invention, there are two specific methods of communication with the Player. In a first method of communication, a specific driver allows interaction between the kiosk and the player only if the driver is loaded to the kiosk terminal (this eliminates unauthorized PC connections). The “mass-storage” capabilities may be excluded from the driver to eliminate the risk of using the player as a flash drive.

1. In a second method of communication between the kiosk and the player, a .COM object or .NET assembly is loaded in real-time by the kiosk application or software library and is compiled to the kiosk application with the following functions:
Int GetInmateID (string PassKey)—return inmate id or −1 if wrong passkey or inmate id is not available. Passkey may be defined as a predefined string used for security purposes.
Int PutInmateID (string PassKey, string id)—store a new id on the device.
Bool ChangePassKey (string currenPassKey, string newPassKey)—change the passkey.
Int GetDevice serialID (string PassKey)—get a unique serial id (optional).

The following functions lock the player if the special driver is not available. The kiosk application locks the player after download and unlocks it again before the next download.

Bool LockDevice (string PassKey)—disable the device from receiving any files until unlock function is called (Bool UnLockDevice (string PassKey)—enable device for receiving any files.
Bool RemoveLock (String passkey)—remove the locking (i.e. allow receive files from any source).

The foregoing description of possible implementations consistent with the present invention does not represent a comprehensive list of all such implementations or all variations of the implementations described. The description of only some implementation should not be construed as an intent to exclude other implementations. Artisans will understand how to implement the invention in many other ways, using equivalents and alternatives that do not depart from the scope of the following claims. Moreover, unless indicated to the contrary in the preceding description, none of the components described in the implementations are essential to the invention.

1. A process for exchanging content with correction facility inmates while giving supervisory authorities the ability to screen the content, comprising:
providing a first database residing on a first global server, having an entry for each inmate and having a plurality of fields, wherein the fields include inmate name, inmate identification code, and facility code, wherein the facility code maps to a specific corrections facility;
transmitting a digital file, intended for a specific inmate, to a second database, said digital file including a photo, an image of a letter, a song, or a video;
associating said transmitted digital file with a corresponding inmate name, inmate identification code, and facility code;
routing said digital file to a local facility computer system based on said facility code;
authenticating an inmate based on the facility code, the inmate name, and the inmate identification code; and
granting access to said file to the inmate after said authentication step.

2. The method of claim 1, wherein said second database resides on an aggregator server.

3. The method of claim 1, wherein said second database and said first database are the same.

4. The method of claim 1, wherein said local facility computer system comprises:
a local server; and
a kiosk terminal.

5. The method of claim 4, wherein said local facility computer system further comprises a computer for locally managing content downloads.

6. The method of claim 4, further comprising the step of displaying at the kiosk terminal a catalog of digital content.

7. The method of claim 4, wherein the digital content includes music.

8. The method of claim 6, further comprising adding digital content titles to a digital shopping cart.

9. The method of claim 8, further comprising downloading digital content corresponding to said titles to a digital content player.

10. The method of claim 4, further comprising displaying the image of a letter at the kiosk terminal.

11. The method of claim 4, further comprising scanning a letter into the kiosk terminal.

12. The method of claim 4, further comprising recording a video message at the kiosk terminal.

13. A system for exchanging content with correction facility inmates while giving supervisory authorities the ability to screen the content, comprising:
a first database having an entry for each inmate and having a plurality of fields, wherein the fields include inmate name, inmate identification code, and facility code, the facility code mapping to a specific corrections facility;
a first global server for associating a digital file, intended for a specific inmate, with a corresponding inmate name, inmate identification code, and facility code; and
a local facility computer system and for receiving said digital file; wherein the local facility computer system comprises a kiosk terminal for authenticating an inmate based on the facility code, the inmate name, and the inmate identification code.

14. The system of claim 13, further comprising an aggregator server for providing access to digital content from the kiosk terminal.

15. The system of claim 13, wherein the local facility computer system further comprises a local server.

16. The system of claim 13, wherein the local facility computer system further comprises a local download manager for managing content downloads into the kiosk terminal.

17. The system of claim 15, wherein the local server further comprises a local download manager for managing content downloads into the kiosk terminal.

18. The system of claim 13, wherein the file includes and image of a letter and the kiosk terminal comprises a display for displaying said image to an authenticated inmate.

19. The system of claim 13, further comprising a digital content player for downloading said digital content file after inmate authentication.

20. A computer-readable medium having stored thereon instructions that, when executed, direct one or more computers implement a method comprising:
transmitting a digital file, intended for a specific inmate, to a database, said digital file including a photo, an image of a letter, a song, or a video;
associating said transmitted digital file with corresponding inmate name, inmate identification code, and facility code fields in the database;
routing said digital file to a local facility computer system based on said facility code;
authenticating an inmate based on the facility code, the inmate name, and the inmate identification code; and
granting access to said file to the inmate after said authentication step.
